(19) United States
(12) Patent Application Publication
(10) Pub. No.: US 2026/0027906 A1
(43) Pub. Date: Jan. 29, 2026

(54) METHOD FOR OPERATING A HIGH VOLTAGE ON-BOARD POWER SUPPLY OF A VEHICLE

(71) Applicant: MERCEDES-BENZ GROUP AG, Stuttgart (DE)

(72) Inventor: Urs BOEHME, Ehningen (DE)

(21) Appl. No.: 18/996,168

(22) PCT Filed: Jul. 13, 2023
(86) PCT No.: PCT/EP2023/069591

§ 371 Date: Jan. 17, 2025

(30) Foreign Application Priority Data
Jul. 18, 2022 (DE) 10 2022 002 627.9

(51) Int. Cl. B60L 3/04; B60L 3/00; B60L 3/12; B60L 53/10; B60L 53/20

(52) U.S. Cl. CPC B60L 3/04; B60L 3/0069; B60L 3/12; B60L 53/11; B60L 53/20; B60L 2210/10

(57) ABSTRACT

A method for operating a high voltage on-board power supply of a vehicle having a protective device for when physical contact with the high voltage potentials and a reference potential when charging a high voltage battery by a direct current charging station is provided. The protective device has a voltage measuring device and a protective switch. In one of the high voltage potentials, between the protective device and a direct current charging connection, a galvanically coupled DC/DC converter is arranged and the direct current charging station provides a charging voltage, which is lower than a nominal voltage of the high voltage battery. It is determined whether physical contact with the high volage potential, in which the DC/DC converter is arranged, occurs between the DC/DC converter and the direct current charging station, and this is used as a triggering criterion for controlling the protective circuit and/or a further protective circuit.

### BACKGROUND AND SUMMARY OF THE INVENTION

Exemplary embodiments of the invention relate to a method for operating a high voltage on-board power supply of a vehicle.

As described in the generic document DE 10 2019 008 833 A1, a protective device for an electrical direct current network, an on-board power supply for a vehicle, a vehicle and a direct current charging station are known from the prior art. The protective device comprises a first voltage measuring device between a positive potential line and a reference potential line and a second voltage measuring device between a negative potential line and the reference potential line, or a fault current measuring device in the reference potential line. The protective device furthermore comprises a protective circuit with two protective circuit parts, wherein the first protective circuit part comprises a series circuit of a first discharge resistor and a first circuit breaker between the positive potential line and the reference potential line, and the second protective circuit part comprises a series circuit of a second discharge resistor and a second circuit breaker between the negative potential line and the reference potential line. The first and second circuit breakers can be controlled to close when, determined by the first and/or second voltage measuring device, a predetermined voltage value is not met and/or is exceeded, or the first and/or second circuit breaker can be controlled to close in the event of a fault current measured by means of the fault current measuring device.

DE 10 2017 009 355 A1 discloses a method for operating a first on-board power supply supplied with a first electrical direct current voltage and a second on-board power supply supplied with a second electrical direct current voltage, wherein the first and the second on-board power supplies are electrically coupled by means of an energy coupler having a first clocked energy converter. Here, the first and the second electrical direct current voltages are electrically insulated from an electrical reference potential by means of an electrical insulation device and are monitored by the electrical insulation device. The first and the second on-board power supplies are galvanically coupled by means of the energy coupler, wherein in the event of a fault in the insulation device in a region of one of the two on-board power supplies, the energy coupler controls the electrical potentials of the respective other of the two on-board power supplies in such a way that respective potential differences between these electrical potentials and the reference potential are smaller than a predetermined reference value.

Furthermore, a protective device for an electrical direct current network and a method for the operation thereof as well as an on-board power supply for a vehicle, a vehicle and a direct current charging station are known from the internally known prior art. The protective device comprises a voltage measuring device between a respective potential line and a reference potential line and a protective circuit with a respective series circuit of a protective capacitor, a protective resistor and a respective circuit breaker between the respective potential line and the reference potential line, or with two protective circuit parts with a series circuit of a protective capacitor, a protective resistor and a circuit breaker between the respective potential line and the reference potential line. A discharge resistor is switched in parallel with the protective capacitor and protective resistor, and a series circuit made of a fast discharge resistor and a fast discharge switch is switched in parallel with the protective capacitor or with the protective capacitor and protective resistor. The first and/or second circuit breaker can be controlled to close when at least one tripping criterion is determined by means of the first and/or second voltage measuring device.

A further protective device for an electrical direct current network, an on-board power supply for a vehicle, a vehicle, and a direct current charging station is also known internally as prior art. The protective device comprises a respective voltage measuring device between a respective potential line and a reference potential line and a protective circuit with a circuit breaker between the respective potential line and the reference potential line and at least one resistor, which is formed as a resistor with a fixed resistance value of a maximum of 800Ω or as a voltage-dependent resistor, wherein the respective circuit breaker can be controlled to close when at least one tripping criterion is determined by means of the respective voltage measuring device.

Exemplary embodiments of the invention are directed to an improved method in comparison to the prior art for operating a high voltage on-board power supply of a vehicle.

In a method according to the invention for operating a high voltage on-board power supply of a vehicle with a protective device for protecting a human body in the event of physical contact with one of the high voltage potentials and a reference potential while charging a high voltage battery using a direct current charging station to which the vehicle is attached by means of a charging cable, wherein the protective device respectively has a voltage measuring device and a protective circuit with a circuit breaker between the respective high voltage potential and the reference potential, it is provided that a galvanically coupled DC-DC converter is arranged in one of the high voltage potentials of the high voltage on-board power supply of the vehicle between the protective device and a direct current charging connection of the vehicle, and the direct current charging station provides a charging voltage which is lower than a nominal voltage of the high voltage battery. It is determined whether the physical contact with the high voltage potential, in which the DC-DC converter is arranged, occurs between the DC-DC converter and the direct current charging station, also referred to below as position P2 or second position. This is used as a tripping criterion for controlling the protective circuit, in particular at least one circuit breaker of the protective circuit, and/or to control a further protective circuit, in particular at least one circuit breaker of this further protective circuit, which is arranged between the high voltage potential, in which the DC-DC converter is arranged, and the reference potential in a position between the DC-DC converter and the direct current charging connection.

According to the invention, it is provided that a slope of the measured voltage between the high voltage potential, in which the DC-DC converter is arranged, and the reference potential is used to determine whether physical contact is made between the DC-DC converter and the direct current charging station, i.e., at position P2.

In particular, it is provided that when it has been determined that physical contact with the high voltage potential, in which the DC-DC converter is arranged, is made between the DC-DC converter and the direct current charging station, i.e., at position P2, and, in addition, a voltage of the high voltage potential, in which the DC-DC converter is arranged, in relation to the reference potential between the DC-DC converter and the direct current charging station immediately before the physical contact does not exceed a predetermined threshold value, the circuit breakers are not closed.

In particular, it is provided that, when it has been determined that physical contact with the high voltage potential, in which the DC-DC converter is arranged, is made between the DC-DC converter and the direct current charging station, i.e., at position two, and in addition, the voltage of the high voltage potential, in which the DC-DC converter is arranged, in relation to the reference potential between the DC-DC converter and the direct current charging station immediately before the physical contact exceeds the predetermined threshold value, at least the circuit breaker between the high voltage potential, in which the DC-DC converter is arranged, and the reference potential is closed and then opened again. Here, this circuit breaker is closed until a current voltage of the high voltage potential, in which the DC-DC converter is arranged, in relation to the reference potential between the DC-DC converter and the direct current charging station is zero, and then opened again, and/or it is closed until a current voltage of the high voltage potential, in which the DC-DC converter is arranged, in relation to the reference potential between the DC-DC converter and the high voltage battery is as large as a difference between a voltage of the high voltage potential, in which the DC-DC converter is arranged, in relation to the reference potential between the DC-DC converter and the high voltage battery immediately before the physical contact and the voltage of the high voltage potential, in which the DC-DC converter is arranged, in relation to the reference potential between the DC-DC converter and the direct current charging station immediately before the physical contact, and then opened again.

Alternatively or additionally, it is provided that, when it has been determined that physical contact with the high voltage potential, in which the DC-DC converter is arranged, is made between the DC-DC converter and the direct current charging station, i.e., at position P2, and in particular when, in addition, the voltage of the high voltage potential, in which the DC-DC converter is arranged, in relation to the reference potential between the DC-DC converter and the direct current charging station immediately before physical contact exceeds the predetermined threshold value, the at least one circuit breaker of the further protective circuit, which is arranged between the high voltage potential, in which the DC-DC converter is arranged, and the reference potential at the position between the DC-DC converter and the direct current charging connection, is closed.

In particular, the slope is compared to a predetermined threshold value, wherein it is ascertained, in particular, whether the threshold value is met or exceeded, and thus determined whether physical contact is made between the DC-DC converter and the direct current charging station.

In particular, it is provided that at least one electrical resistor is switched between the high voltage potential, in which the DC-DC converter is arranged, and the reference potential by closing the respective circuit breaker, i.e., the protective circuit of the protective device and/or the further protective circuit has at least this resistor. The protective circuit of the protective device and/or the further protective circuit can additionally have further components. In particular, the protective circuit is formed as described in DE 10 2019 008 833 A1, DE 10 2021 003 834 and/or DE 10 2021 003 835.

The solution described ensures correct functioning of the protective device and its protective circuit even when the high voltage on-board power supply has the galvanically coupled DC-DC converter, and physical contact with the high voltage potential, in which this DC-DC converter is arranged, is made at the position P2, i.e., between the DC-DC converter and the direct current charging station. This also ensures a rapid discharge of Y capacitors in this case and thus avoids an electric shock with an intensity that is dangerous to humans.

In the solution described, the voltage measurement of the high voltage potentials in relation to the reference potential is considered in particular. By differentiating the voltage (forming the derivative), the original output voltage can be deduced from the slope of the voltage curve. Using the output voltage, it can then be concluded by comparing them to threshold values as to whether the physical contact and thus the body discharge takes place on the primary side or on the secondary side of the DC-DC converter.

Exemplary embodiments of the invention are explained in more detail below by means of a drawing.

### BRIEF DESCRIPTION OF THE SOLE DRAWING

### Here is Shown:

The sole drawing, schematically, a vehicle coupled to a direct current charging station.

### DETAILED DESCRIPTION

The sole FIGURE shows a schematic depiction of a vehicle 2 coupled to a direct current charging station 5. The vehicle 2 has a high voltage on-board power supply 3 with high voltage potentials HV+, HV−, i.e., with a positive potential HV+ and a negative potential HV−, and with a reference potential M, in particular mass or earth potential. Furthermore, the high voltage on-board power supply 3 has a protective device 8 for protecting a human body MK in the event of physical contact with one of the high voltage potentials HV+, HV− and the reference potential M when charging a high voltage battery 6 by the direct current charging station 5. In the state coupled to the direct current charging station 5, the high voltage on-board power supply 3 forms a common direct current network 1 with this. The high voltage battery 6 of the vehicle 2, which is electrically charged on the direct current charging station 5, serves, in particular, to provide electrical energy for at least one electrical drive unit of the vehicle 2 for driving the vehicle 2.

Both in the vehicle 2 and in the direct current charging station 5, Y capacitors CyF+, CyF−, CyL+, CyL− are used as a measure in order to reduce an emission of EMC interference (EMC=electromagnetic compatibility). In particular, Y capacitors CyF+, CyF−, CyL+, CyL− are usually more favorable and more compact EMC filter measures compared to inductive interference suppression filters, for example common or differential mode chokes. From an EMC point of view, it would therefore be advantageous to use Y capacitors CyF+, CyF−, CyL+, CyL− with large capacitance values.

However, a disadvantage of an electrified vehicle 2, i.e., an electric vehicle or hybrid vehicle, for example, is that an energy content of the Y capacitors CyF+, CyF−, CyL+, CyL− can be felt by a vehicle user when they can touch a high voltage potential HV+, HV− and are simultaneously in contact with the earth potential. They then receive an electric shock. Depending on the size of this electric shock, this can be hazardous to health. For example, it can lead to ventricular fibrillation or death. Such an electric shock represents a so-called “single fault” and must be avoided. Thus, this energy content of the Y capacitors CyF+, CyF−, CyL+, CyL− is limited by standards in order to rule out any risk to the vehicle user.

From the point of view of high voltage safety, small capacitance values of the Y capacitors CyF+, CyF−, CyL+, CyL− are thus advantageous. Standards, such as regulation LV123, stipulate that a maximum energy content, in particular 0.2 J, must not be exceeded in the Y capacitors CyF+, CyF−, CyL+, CyL− or that so-called “alternative measures”, i.e., alternative measures, for example increased insulation, must be provided. However, this always means that when coupling two high voltage systems, for example vehicle 2 and direct current charging station 5, if reinforced insulation is selected as an “alternative measure”, the two participants must always have this reinforced insulation at the same time. However, this cannot currently be guaranteed.

In other standards, for example IEC 1772, IEC 60479-1 and IEC60479-2, it is not the energy content of the Y capacitors CyF+, CyF−, CyL+, CyL− that is specified as a hazardous quantity that must not be exceeded, but a charge quantity that must not exceed a specified value is specified as a harmful mechanism. For example, a graph of a relation of a duration of a body current over a value of the body current is given. An alternative method, such as increased insulation, for example, is not accepted here.

The sole FIGURE shows a circuit configuration of an embodiment of the high voltage on-board power supply 3 during a direct current charging process of the vehicle 2. The high voltage on-board power supply 3 of the vehicle 2 is coupled to the direct current charging station 5 by means of a charging cable 4. In the example shown, here, the charging cable 4 is already connected to connection contacts AK+, AK− of a direct current charging connection of the vehicle 2, and charging contactors LS+, LS− of the vehicle 2 in high voltage potential lines HV+L, HV−L are still open. They are closed for charging.

On the left-hand side is the direct current charging station 5 with a charging station voltage source SQ, a charging station internal resistor Rus, and the Y capacitors CyL+, CyL−.

The charging cable 4 is depicted on the right of the direct current charging station 5.

To the right, the vehicle 2 is depicted with its high voltage on-board power supply 3, comprising the charging contactors LS+, LS−, the Y capacitors CyF+, CyF−, for example EMC filters, an X capacitor Cx, for example of a direct intermediate circuit, and the high voltage battery 6 with its main contactors HS+, HS−. The high voltage battery 6 is depicted as an electrical battery energy source 7, comprising, for example, a plurality of individual cells switched electrically in series and/or in parallel, with an internal battery resistance R_{Batt}.

In addition, in this circuit diagram, the human body MK with a body resistance R_{K} and a switch symbol for an insulation fault IF is depicted, for example in the case of a defective charging cable 4, in this example a fault at the positive potential HV+. The insulation fault IF can also occur at the negative potential HV−. This is not depicted here. If the insulation fault IF occurs, the switch symbol is closed. In the event of such an insulation fault IF and contact between the human body MK and one of the high voltage potentials HV+, HV− and a reference potential M, a discharge occurs through the human body MK.

In order to avoid this discharge through the human body MK or at least to reduce it to a permissible level, in particular with regard to a health hazard, the protective device 8 is provided with a protective circuit 9 for reducing the electric shock through the Y capacitors CyF+, CyF−, CyL+, CyL−. The protective device 8 comprises a first voltage measuring device SV1 between the positive potential line HV+L and the reference potential line ML for measuring a voltage between the positive potential line HV+L and the reference potential line ML, i.e., between the positive potential HV+ and the reference potential M, in particular earth potential, in particular of the vehicle body shell, and a second voltage measuring device SV2 between the negative potential line HV−L and the reference potential line ML for measuring a voltage between the negative potential line HV−L and the reference potential line ML, i.e., between the negative potential HV− and the reference potential M, in particular earth potential, in particular of the vehicle body shell. The voltage measurements, in particular the voltage measuring devices SV1, SV2, control a corresponding circuit breaker SS1, SS2 when at least one predetermined tripping criterion occurs. The circuit breakers SS1, SS2 are, for example, each designed as a semiconductor switch, such as a MOSFET, for example. As a result, a discharge network is switched between the positive potential HV+ and the reference potential M, in particular the shell construction mass, or a discharge network is switched between the negative potential HV− and the reference potential M, in particular the shell construction mass. In the example depicted, these discharge networks are protective circuit parts 9.1, 9.2 of the protective circuit 9.

The respective discharge network, i.e., the respective protective circuit part 9.1, 9.2, comprises at least one electrical resistor via which the Y capacitors CyF+, CyF−, CyL+, CyL− are discharged. In the example depicted, the respective discharge network preferably consists of an uncharged capacitor, referred to below as protective capacitor Cs1, Cs2, and a resistor switched electrically in parallel, referred to below as discharge resistor Re1, Re2. In addition, a protective resistor Rs1, Rs2 is provided, which is electrically switched in series with the protective capacitor Cs1, Cs2. For example, only the discharge resistor Re1, Re2 could also be provided.

As far as described so far, the high voltage on-board power supply 3 including the protective device 8 corresponds to that of DE 10 2019 008 833 A1. For further information on its structure and mode of operation, reference is thus made to this DE 10 2019 008 833 A1, in particular to its figures and figure description. Further examples of such high voltage on-board power supplies 3 with protective device 8 are described in DE 10 2021 003 834 and in DE 10 2021 003 835. They differ substantially in the structure of the protective device, in particular in the components of the discharge network.

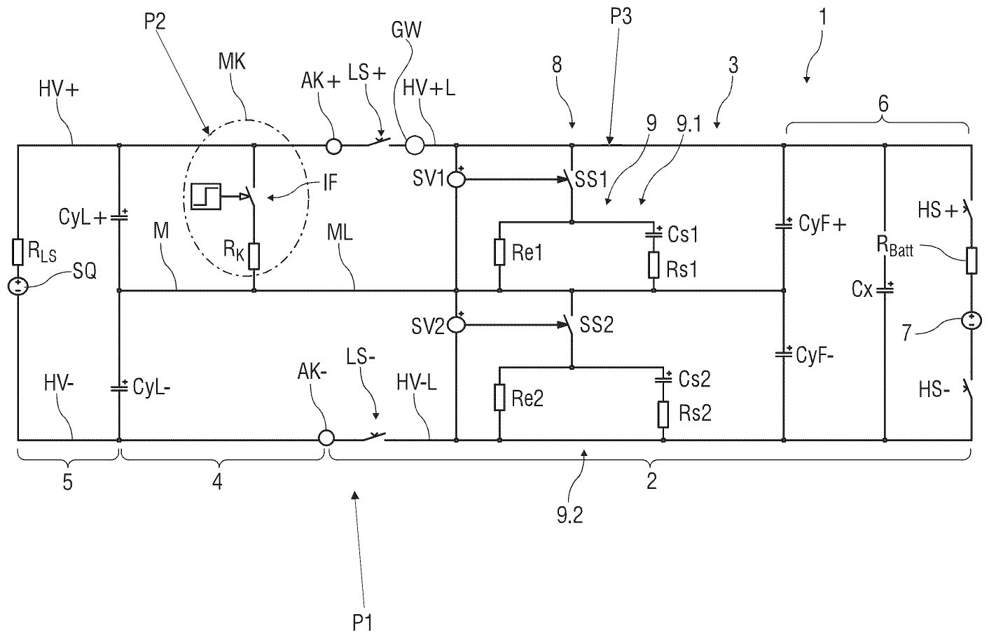

For the solution described below, the protective devices 8 described in DE 10 2019 008 833 A1, in DE 10 2021 003 834 and in DE 10 2021 003 835 and their respective mode of operation for the high voltage on-board power supply 3 of the vehicle 2 can be used, i.e., the protective device 8 depicted in FIG. 1 can also be designed in the form of another of the embodiments described in DE 10 2019 008 833 A1, DE 10 2021 003 834 and DE 10 2021 003 835 and function as described there.

The main difference between the high voltage on-board power supply 3 depicted here and the high voltage on-board power supplies 3 depicted and described in DE 10 2019 008 833 A1, DE 10 2021 003 834 and DE 10 2021 003 835 is that in the high voltage on-board power supply 3 of the vehicle 2 depicted and described here in one of the high voltage potentials HV+, HV−, in the example depicted here in the positive potential HV+, a galvanically coupled DC/DC converter GW is arranged between the protective device 8 and the direct current charging connection of the vehicle 2. This makes it possible to charge the high voltage battery 6 at a direct current charging station 5 that provides a charging voltage that is lower than a nominal voltage of the high voltage battery 6. The direct current charging station 5 depicted is such a direct current charging station 5.

This DC/DC converter GW has an effect on the action of the protective device 8 when the insulation fault IF and the physical contact described above between one of the high voltage potentials HV+, HV− and the reference potential M with the high voltage potential, in which the DC/DC converter GW is arranged, occurs between the DC/DC converter GW and the direct current charging station 5. In the example depicted here, this high voltage potential is the positive potential HV+. In other examples, the DC/DC converter GW can also be arranged at the negative potential HV−, such that this negative potential HV− would then be affected. This position of the physical contact with the high voltage potential, in which the DC/DC converter GW is arranged, between the DC/DC converter GW and the direct current charging station 5, which is critical for the effect of the protective device 8, is referred to below as position P2.

The other possible positions in which the physical contact between one of the high voltage potentials HV+, HV− and the reference potential M could occur are the other high voltage potential, in the example depicted the negative potential HV−, referred to below as position P1, and the high voltage potential, in which the DC/DC converter GW is arranged, between the DC/DC converter GW and the high voltage battery 6, referred to below as position P3. At these two other positions P1 and P3, the physical contact is not critical for the protective device 8, in particular for its mode of operation and mode of action, even when the galvanically coupled DC/DC converter GW is used in the high voltage on-board power supply 3 of the vehicle 2. If the physical contact with one of the high voltage potentials HV+, HV− thus occurs at one of these two positions P1, P3, the protective device 8 continues to operate as described in DE 10 2019 008 833 A1, in DE 10 2021 003 834 or in DE 10 2021 003 835, in particular in their figures and figure description, and here achieves the same effect as described there.

If physical contact occurs at position P3, i.e., between the DC/DC converter GW and the high voltage battery 6, then the voltage between the high voltage potential contacted by the body MK and the reference potential M at position P3 is reduced to OV by means of the protective device 8. At position P2, the voltage between this high voltage potential and the reference potential M is reduced by the same voltage amount as at position P3. Since the output voltage between this high voltage potential and the reference potential M at position P2 is reduced by the voltage value of the DC/DC converter GW, the final value is also a significantly lower or even negative voltage. However, since physical contact does not occur at position P2, but at position P3, this is of no significance. At position P3, where physical contact takes place, the voltage is quickly reduced. The mode of operation of the protective device, as described in DE 10 2019 008 833 A1, DE 10 2021 003 834 or DE 10 2021 003 835, is thus advantageous for physical contact at position P3 and is thus also retained in the solution described here for the body contact at position P3.

If physical contact is made at position P2, i.e., between the DC/DC converter GW and the direct current charging station 5, the voltage between the high voltage potential contacted by the body MK and the reference potential M at position P3 is only reduced by a small value, namely by the voltage between this high voltage potential and the reference potential M at position P2. The voltage between this high voltage potential and the reference potential M is reduced to the value OV at position P2 on a capacitor discharge curve. Switching on the protective circuit 9 of the protective device 8 at position P3, as described in DE 10 2019 008 833 A1, in DE 10 2021 003 834 or in DE 10 2021 003 835, would abruptly reduce the voltage at position P3 to OV. As a result, the voltage between the high voltage potential contacted by the body MK and the reference potential M at position P2 is reduced by the voltage value that prevailed at position P3 at the time of switching on. Due to the change in sign, since the output voltage at position P2 is lower than at position P3, the amount of voltage at position P2 then increases and thus represents an even greater danger than without the protective circuit 9 of the protective device 8 being switched on.

If the physical contact occurs at position P1, i.e., at the high voltage potential at which the DC/DC converter GW is not arranged, thus at the negative potential HV− in the example depicted here, then the voltage between the high voltage potential contacted by the body MK and the reference potential M at position P1 is reduced to OV by means of the protective device 8. The voltage between the other high voltage potential and the reference potential M increases by the same amount both at position P2 and at position P3. However, since in this case contact by the human body MK occurs at position P1, this is irrelevant since the voltage is quickly reduced here. The mode of operation of the protection device, as described in DE 10 2019 008 833 A1, DE 10 2021 003 834 or DE 10 2021 003 835, is thus advantageous for physical contact at position P3 and is thus also retained in the solution described here for physical contact at position P3.

As can be seen from the preceding descriptions, it is thus necessary to distinguish whether the body MK came into contact with the high voltage potential at position P2 or P3, in which the DC/DC converter GW is arranged. In particular, it must be determined whether the body MK came into contact with the high voltage potential in which the DC/DC converter GW is arranged at position P2, since then a different mode of operation of the protective device 8, in particular the protective circuit 9, is required than described in DE 10 2019 008 833 A1, in DE 10 2021 003 834 or in DE 10 2021 003 835.

In the solution described here, it is thus provided that it is determined whether the physical contact with the high voltage potential, in which the DC/DC converter GW is arranged, occurs between the DC/DC converter GW and the direct current charging station 5, i.e., whether the physical contact occurs at position P2. Since the respective position P1, P2, P3, in particular position P2, must be recognized very quickly so that the protective device 8, in particular its protective circuit 9, takes the correct action, it is not possible to wait for the discharge curve, i.e., the e-function of the capacitor discharge of the Y capacitors CyF+, CyF−, CyL+, CyL−, to decay.

The distinguishing feature used for the solution described here is the slope of the discharge curve, i.e., the derivative of the discharge curve. The slope of the measured voltage between the high voltage potential, in which the DC/DC converter GW is arranged, and the reference potential M is thus used to determine whether physical contact is made between the DC/DC converter GW and the direct current charging station 5. Here, the voltage is measured by means of the voltage measuring device provided for measuring the voltage between this high voltage potential and the reference potential M, in the example depicted here thus by means of the first voltage measuring device SV1.

The mesh equation for the high voltage potential in which the DC/DC converter GW is arranged applies, in this case for the positive potential HV+:

$${U}_{P 3} ( t ) = {U}_{GW} + {U}_{P 2} ( t ) \qquad ( 1 )$$

Here,
U_{P3}(t) is the voltage between the high voltage potential, in which the DC/DC converter GW is arranged, here the positive potential HV+, and the reference potential M at position P3,
U_{P2}(t) is the voltage between the high voltage potential, in which the DC/DC converter GW is arranged, here the positive potential HV+, and the reference potential M at position P2,
U_{GW} is the voltage of the DC/DC converter GW.

Based on the position P3, a body discharge at position P3 has the following course:

$${U}_{P 3} ( t ) = {U}_{0 P 3} * {e}^{\frac{t}{R * C}} \qquad ( 2 )$$

and the following applies for its slope (derivative):

$$\frac{{dU}_{P 3} ( t )}{dt} = - \frac{1}{R * C} {U}_{0 P 3} * {e}^{- \frac{t}{R * C}} \qquad ( 3 )$$

Based on the position P3, a body discharge at position P2 has the following course:

$${U}_{P 3} ( t ) = {U}_{GW} + {U}_{0 P 2} * {e}^{- \frac{t}{R * C}} \qquad ( 4 )$$

and the following applies for its slope (derivative):

$$\frac{{dU}_{P 3} ( t )}{dt} = - \frac{1}{R * C} {U}_{0 P 2} * {e}^{- \frac{t}{R * C}} \qquad ( 5 )$$

U_{0P3} and U_{0P2} here correspond to the voltages of the high voltage potential, in which the DC/DC converter GW is arranged, in this example thus the positive potential HV+, in relation to the reference potential M at positions P3 and P2 immediately before the body discharge occurs. R is the body resistance R_{K}, and C is the total capacitance of the Y capacitors to be discharged CyF+, CyF−, CyL+, CyL−.

When looking at the two derivatives, there is a difference in the slope depending on the position of the body contact. In the case of contact at position P3, the formula of the derivative (formula (3)) contains the factor U_{0P3}, while in the case of contact at position P2, the derivative (formula (5)) contains the factor U_{0P2}.

The location of the body contact can thus be detected without delay using the slope, and the correct behavior of the protective device 8, in particular its protective circuit 9, can thus also be determined immediately. For this purpose, the determined slope is compared, in particular, to at least one predetermined threshold value. In particular, it is determined whether this threshold value is not met or exceeded. This comparison is used to ascertain whether the physical contact occurs at position P2 or not.

The slope (derivative) can be ascertained, for example, using a capacitor circuit, an operational amplifier (differentiator) or by multiple sampling, i.e. measuring the voltage using the relevant, in this case the first, voltage measuring device SV1, and calculating it.

In the following, reaction possibilities of the protective device 8 for the determined physical contact at the respective position P1, P2, P3 are described, or in particular when it has been determined that the physical contact occurs at position P2, since when the physical contact occurs at positions P1 and P3, i.e. when it is not determined that the physical contact takes place at position P2, then short-circuiting/rapid discharging of the affected high voltage potential takes place by means of the protective device 8 and its protective circuit 9 in the manner described in DE 10 2019 008 833 A1 and/or in DE 10 2021 003 834 and/or in DE 10 2021 003 835.

The main difference to DE 10 2019 008 833 A1, DE 10 2021 003 834m and DE 10 2021 003 835 is thus the determination of whether the physical contact occurs at position P2 and, when this is the case, the different procedure. The triggering criterion for triggering the protective circuit 9, i.e., for closing at least one or both circuit breakers SS1, SS2, of position P1, P2, P3 of the physical contact is therefore added, in particular the triggering criterion of whether or not the physical contact occurs at position P2, or the triggering criterion that the physical contact occurs at position P2. As described above, this trigger criterion, i.e., its presence, is determined in particular based on the voltage slope over time t between the high voltage potential, in which the DC/DC converter GW is arranged, in the example shown here the positive potential HV+, and the reference potential M, in particular according to formula (5).

When it has thus been determined that physical contact with the high voltage potential, in which the DC/DC converter GW is arranged, in the example depicted thus with the positive potential HV+, occurs between the DC/DC converter GW and the direct current charging station 5, i.e., at position P2, then there are several possibilities for the mode of operation of the protective device 8, in particular its protective circuit 9, which must then be carried out:
No action by the protective device 8 when the voltage does not lead to any danger to humans, i.e., the recharging of the Y capacitors CyF+, CyF−, CyL+, CyL− by the amount of U_{0P2} does not lead to any predetermined, in particular legally prescribed, limit values being exceeded. When the voltage U_{0P2} of the high voltage potential, in which the DC/DC converter GW is arranged, in relation to the reference potential M between the DC/DC converter GW and the direct current charging station 5, i.e., at position P2, immediately before the physical contact, does not exceed a predetermined limit value, the circuit breakers SS1, SS2 are not closed.
Discharge of the high voltage potential, in which the DC/DC converter GW is arranged, in the example depicted here the positive potential HV+, in relation to the reference potential M at position P3 by the voltage value U_{0P2}, i.e., by the value of the voltage of the high voltage potential, in which the DC/DC converter GW is arranged, in relation to the reference potential M between the DC/DC converter GW and the direct current charging station 5, i.e., at position P2, immediately before physical contact. This can be achieved, for example, by closing the relevant circuit breaker, here the first circuit breaker SS1, and opening it again. Here, opening takes place, for example, as soon as a voltage of U_{0P3}-U_{0P2} is present at position P3 between the high voltage potential, in which the DC/DC converter GW is arranged, and the reference potential M, i.e., until this voltage corresponds to the difference between the voltage U_{0P2} of the high voltage potential, in which the DC/DC converter GW is arranged, in relation to the reference potential M between the DC/DC converter GW and the direct current charging station 5, i.e., at position P2, and the reference potential M between the DC/DC converter GW and the direct current charging station 5, i.e., at position P2, in relation to the voltage U_{0P3} of the high voltage potential, in which the DC/DC converter GW is arranged, in relation to the reference potential M between the DC/DC converter GW and the high voltage battery 6, i.e., at position P3, immediately before the physical contact. Alternatively, opening takes place, for example, when the voltage between this high voltage potential and the reference potential M is OV at position P2, i.e. in the high voltage potential, in which the DC/DC converter GW is arranged, between the DC/DC converter GW and the direct current charging station 5. In particular, when the voltage U_{0P2} of the high voltage potential, in which the DC/DC converter GW is arranged, in relation to the reference potential M between the DC/DC converter GW and the direct current charging station 5, i.e., at position P2 immediately before the physical contact exceeds the predetermined limit value, at least the circuit breaker SS1 between the high voltage potential, in which the DC/DC converter GW is arranged, and the reference potential M is closed until the current voltage of the high voltage potential, in which the DC/DC converter GW is arranged, in relation to the reference potential M between the DC/DC converter GW and the direct current charging station 5 is zero, and then opened again, and/or until a current voltage of the high voltage potential, in which the DC/DC converter GW is arranged, in relation to the reference potential M between the DC/DC converter GW and the direct current charging station 5 is as large as a difference between the voltage of the high voltage potential, in which the DC/DC converter GW is arranged, in relation to the reference potential M between the DC/DC converter GW and the high voltage battery 6 immediately before physical contact and the voltage of the high voltage potential, in which the DC/DC converter GW is arranged, in relation to the reference potential M between the DC/DC converter GW and the direct current charging station 5 immediately before physical contact, and then opened again.

For these two possibilities according to the above two diagrams, it is necessary to know as precisely as possible the voltage U_{0P2} of the high voltage potential, in which the DC/DC converter GW is arranged, in relation to the reference potential M between the DC/DC converter GW and the direct current charging station 5, i.e. at position P2, immediately before physical contact. This voltage U_{0P2} can be determined from the transformation ratio of the DC/DC converter GW and from the voltage U_{0P3} of the high voltage potential, in which the DC/DC converter GW is arranged, measured by means of the corresponding voltage measuring device, here the first voltage measuring device SV1, in relation to the reference potential M between the DC/DC converter GW and the high voltage battery 6, i.e., at position P3, immediately before the physical contact, or can be measured directly at an input of the DC/DC converter GW by means of a further voltage measuring device.

As an alternative to these two possibilities, in particular as an alternative to the possibility described in the second diagram above, discharging can also take place at position P2, for example. For this purpose, a further discharge circuit, in particular a further discharge network, in particular a further protective circuit 9, is required between the high voltage potential, in which the DC/DC converter GW is arranged, and the reference potential at position P2, i.e., between the DC/DC converter GW and the direct current charging station 5. To realize this possibility, the high voltage on-board power supply 3 thus has such a further discharge circuit, in particular a further protective circuit 9, at this position P2. This is advantageously designed as described in DE 10 2019 008 833 A1 and/or in DE 10 2021 003 834 and/or in DE 10 2021 003 835.

When using this further protective circuit, in particular when the voltage U_{0P2} of the high voltage potential, in which the DC/DC converter GW is arranged, in relation to the reference potential M between the DC/DC converter GW and the direct current charging station 5, i.e., at position P2, exceeds the predetermined limit value immediately before physical contact, at least one further protective circuit 9 between the high voltage potential, in which the DC/DC converter GW is arranged, and the reference potential M in the region of position P2, i.e., between the DC/DC converter GW and the direct current charging connection, is closed.

To better distinguish or respond more quickly, in addition to the above-described slope of the measured voltage between the high voltage potential, in which the DC/DC converter GW is arranged, and the reference potential M, yet further measured variables can be used, for example the current value of the voltage measurement of the high voltage potential, in which the DC/DC converter GW is arranged, in the example depicted here thus the positive potential HV+, in relation to the reference potential M, determined here by means of the first voltage measuring device SV1, or its average value over a predetermined period of time. For example, a predetermined limit value for this current value of the voltage measurement or an average value can be predetermined. The circuit breaker SS1 of the protective circuit 9 then closes when this limit value is not met, the calculated slope of the measured voltage between the high voltage potential, in which the DC/DC converter GW is arranged, and the reference potential M has a value of less than −1e5, for example, and the circuit breaker of the additional protective circuit 9 is open. This circuit breaker of the further protective circuit 9 is closed, for example, when the above-mentioned limit value of the voltage measurement is not met and, at the same time, the calculated slope of the measured voltage between the high voltage potential, in which the DC/DC converter GW is arranged, and the reference potential M has a value between −1e4 and −1e5, for example. In addition, the first circuit breaker SS1 of the protective circuit 9 must not be closed.

In the solution described, the position P1, P2, P3 of the physical contact can thus be inferred, in particular by means of the slope of the discharge curve, and the correct reaction of the protection device 8 can then be carried out. The solution described is particularly suitable for vehicles 2 with a galvanically coupled DC/DC converter GW and/or with at least one inverter operated as a DC/DC converter. Here, the galvanically coupled DC/DC converter GW can also be used, for example, to supply auxiliary units. The solution can also be used for direct current charging stations 5, consisting of a galvanically insulating DC/DC converter and/or a battery and a galvanically coupled converter.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMBERS

1 Direct current network
2 Vehicle
3 High voltage on-board power supply
4 Charging cable
5 Direct current charging station
6 High voltage battery
7 Battery energy source
8 Protection device
9 Protection circuit
9.1, 9.2 Protection circuit part
AK+, AK− Connection contact of a direct current charging connection
Cs1, Cs2 Protective capacitor
Cx X-capacitor
CyF+, CyF−Y-capacitor vehicle
CyL+, CyL− Y-capacitor direct current charging station
GW DC/DC converter
HS+, HS− Main contactor
HV+ Positive potential
HV− Negative potential
HV+L Positive potential line
HV−L Negative potential line
IF Insulation fault
LS+, LS− Charging contactor
M Reference potential
ML Reference potential line
MK Body
P1, P2, P3 Position
R_{Batt} Internal battery resistance
R_{K} Body resistance
R_{LS} Internal charging station resistance
Re1, Re2 Discharge resistor
Rs1, Rs2 Protective resistor
SQ Charging station voltage source
SS1, SS2 Circuit breaker
SV1, SV2 Voltage measuring device

1-4. (canceled)

5. A method for operating a high voltage on-board power supply of a vehicle, the method comprising:
measuring, by a voltage measuring device, a voltage between a high voltage potential of the high voltage on-board power supply and a reference potential of the high voltage on-board power supply, wherein the high voltage on-board power supply comprises a protective device for protecting a human body in event of physical contact with the high voltage potential and the reference potential when charging a high voltage battery of the vehicle using a direct current charging station, wherein the vehicle is attached to the direct current charging station by a charging cable, wherein, between the high voltage potential and the reference potential, the protective device includes the voltage measuring device and a protective circuit with a circuit breaker, wherein a galvanically coupled DC/DC converter is arranged in the high voltage potential between the protective device and a direct current charging connection of the vehicle, and wherein the direct current charging station provides a charging voltage that is lower than a nominal voltage of the high voltage battery;
determining a slope of the measured voltage between the high voltage potential, in which the galvanically coupled DC/DC converter is arranged, and the reference potential;
determining, based the determined slope of the measured voltage, there is the physical contact with the high volage potential between the galvanically coupled DC/DC converter and the direct current charging station; and
determining whether to trigger the protective circuit or a further protective circuit responsive to the determining that there is physical contact, wherein the further protective circuit is arranged between the high voltage potential, in which the galvanically coupled DC/DC converter is arranged, and the reference potential at a position between the galvanically coupled DC/DC converter and the direct current charging connection.

6. The method of claim 5, wherein, responsive to the determining that there is physical contact:
the circuit breaker is not closed when a voltage of the high voltage potential, in which the galvanically coupled DC/DC converter is arranged, in relation to the reference potential between the galvanically coupled DC/DC converter and the direct current charging station does not exceed a predetermined threshold value immediately before physical contact,
when the voltage of the high voltage potential, in which the galvanically coupled DC/DC converter is arranged, in relation to the reference potential between the galvanically coupled DC/DC converter and the direct current charging station exceeds the predetermined threshold value immediately before physical contact, at least the circuit breaker between the high voltage potential, in which the galvanically coupled DC/DC converter is arranged, and the reference potential is closed until a current voltage of the high voltage potential, in which the galvanically coupled DC/DC converter is arranged, in relation to the reference potential between the galvanically coupled DC/DC converter and the direct current charging station is zero, and then opened again, or until a current voltage of the high voltage potential, in which the galvanically coupled DC/DC converter is arranged, in relation to the reference potential between the galvanically coupled DC/DC converter and the high voltage battery is as large as a difference between a voltage of the high voltage potential, in which the galvanically coupled DC/DC converter is arranged, in relation to the reference potential between the galvanically coupled DC/DC converter and the high voltage battery immediately before physical contact and the voltage of the high voltage potential, in which the galvanically coupled DC/DC converter is arranged, in relation to the reference potential between the galvanically coupled DC/DC converter and the direct current charging station immediately before physical contact, and then opened again, or
at least one circuit breaker of the further protective circuit, which is arranged between the high voltage potential, in which the galvanically coupled DC/DC converter is arranged, and the reference potential at the position between the galvanically coupled DC/DC converter and the direct current charging connection, is closed.

7. The method of claim 5, wherein the determined slope is compared to a predetermined threshold value, wherein it is determined whether the predetermined threshold value is not met or is exceeded, and thus it is determined whether the physical contact occurs between the galvanically coupled DC/DC converter and the direct current charging station.

8. The method of claim 5, wherein, by closing the circuit breaker, at least one electrical resistor is switched between the high voltage potential, in which the galvanically coupled DC/DC converter is arranged, and the reference potential.

9. A method for operating a high voltage on-board power supply of a vehicle, wherein the high voltage on-board power supply includes a high voltage potential and a reference potential, the method comprising:
determining the vehicle is attached to a direct current charging station by a charging cable and a high voltage battery of the vehicle is being charged using the direct current charging station;
measuring, by a voltage measuring device of a protective device, a voltage between the high voltage potential and the reference potential of the high voltage on-board power supply, wherein a galvanically coupled DC/DC converter is arranged in the high voltage potential between the protective device and the direct current charging connection of the vehicle, wherein the direct current charging station provides a charging voltage that is lower than a nominal voltage of the high voltage battery;
determining a slope of the measured voltage;
determining, based the determined slope of the measured voltage, there is physical contact with the high volage potential between the galvanically coupled DC/DC converter and the direct current charging station; and
determining whether to trigger a protective circuit of the protective device or a further protective circuit responsive to the determining that there is physical contact, wherein the protective circuit includes a circuit breaker, and wherein the further protective circuit is arranged between the high voltage potential and the reference potential at a position between the galvanically coupled DC/DC converter and the direct current charging connection.
